(19) United States
(12) Patent Application Publication
(10) Pub. No.: US 2006/0010479 A1
(43) Pub. Date: Jan. 12, 2006

(54) Internet television broadcast system

(76) Inventors: Priscilla M. Lu, San Carlos, CA (US); Timothy R. White, Palo Alto, CA (US)

Correspondence Address: IPSG, P.C., P.O. BOX 700640, SAN JOSE, CA, 95170-0640, US

(21) Appl. No.: 11/179,361

(22) Filed: Jul. 11, 2005

Related U.S. Application Data
(60) Provisional application No. 60/586,827, filed on Jul. 9, 2004.

(51) Int. Cl. H04N 7/173

(52) U.S. Cl. 725/112

(57) ABSTRACT

The invention relates to the general field of an Internet television broadcast system. In particular, the invention receives local television programming and then serves that programming to subscribers over the Internet. An exemplary embodiment of an Internet television broadcast system comprises a plurality of television receivers for receiving signals from a plurality of television transmitters. A processor is coupled to the television receivers and configured to selectively store television programs on a storage device and the selectively retrieve television programs from the storage device, and configured to selectively bypass the storage device. An Internet interface coupled to the processor and configured to couple to the Internet. The processor is configured to execute a program to selectively deliver requested television programs to subscribers over the Internet. Advantages of the invention include the ability to view television programs over the Internet.

### RELATED APPLICATIONS

This application claims priority to U.S. Prov. No. 60/586,827, filed Jul. 9, 2004, incorporated herein by reference.

### FIELD

The invention relates to the general field of an Internet television broadcast system. In particular, the invention receives local television programming and then serves that programming to subscribers over the Internet.

### BACKGROUND

Television programming is typically subject to local reception. Conventional television reception is by aerial that can pick up television signals from stations located in the same city.

Cable television can now broadcast national stations and programs to subscribers. For example, subscribers all over the country can receive the same CNN broadcast over their cable television. Likewise, satellite television subscribers can receive programs from all over the world.

However, these two types of broadcast are subject to the programming whims of the cable and satellite providers and do not permit people to see some programs which they may desire to see or to receive programs where there is no cable or satellite signal reception. Also, there is no technique for Internet carriers like SBC or AOL to offer television programming to their subscribers.

What is needed is an Internet television broadcast system that permits subscribers to log onto the Internet and access television programming from around the world in real time, quasi real time or on a delayed basis.

### SUMMARY

The invention relates to the general field of an Internet television broadcast system that permits subscribers to log onto the Internet and access television programming from around the world in real time, quasi real time or on a delayed basis.

An exemplary embodiment of an Internet television broadcast system comprises a plurality of television receivers for receiving signals from a plurality of television transmitters. A processor is coupled to the television receivers and configured to selectively store television programs on a storage device and the selectively retrieve television programs from the storage device, and configured to selectively bypass the storage device. An Internet interface coupled to the processor and configured to couple to the Internet. The processor is configured to execute a program to selectively deliver requested television programs to subscribers over the Internet.

Advantages of the invention include the ability to view television programs over the Internet.

### DRAWINGS

The invention is described with reference to the following figures.

FIG. 1 is an architectural view of an Internet television broadcast system according to an embodiment of the invention;

FIG. 2 depicts an Internet television server according to an embodiment of the invention; and

FIG. 3 depicts an architectural view of an Internet television broadcast system according to an embodiment of the invention.

### DETAILED DESCRIPTION

The invention is described with reference to specific apparatus and embodiments. Those skilled in the art will recognize that the description is for illustration and to provide the best mode of practicing the invention.

The invention relates to the general field of an Internet television broadcast system. In particular, the invention receives local television programming and then serves that programming to subscribers over the Internet.

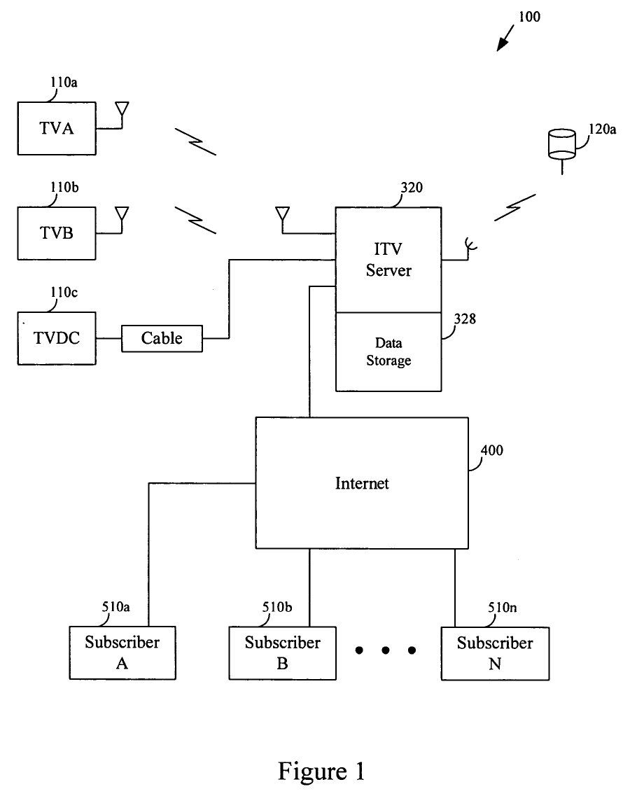

FIG. 1 is an architectural view of an Internet television broadcast system 100 according to an embodiment of the invention. A plurality of television stations 100a-110c are dispersed at geographically diverse locations such as in difference cities. Additionally, television stations can be delivered via satellite 120a. An Internet television (ITV) server 320 receives the signals from the various television stations and manages the programming. In one aspect of the invention, the server 320 stores the programming in Data Storage 328.

The server 320 is coupled to the Internet 400 and can deliver the television programs to subscribers 510a-510n via the Internet. In one aspect of the invention, the television programs are delivered in real time or close to real time. In another aspect of the invention, the television programs are stored in the Data Storage 328 and delivered to subscribers 510a-510n at later times or on demand.

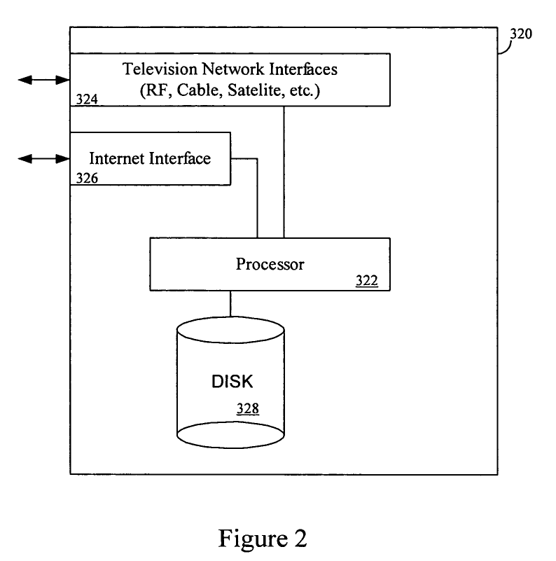

FIG. 2 depicts an Internet television server 320 according to an embodiment of the invention. The server includes a television network interface 324, which is adapted to receive signals from receivers. The receivers can include one or more of aerial television receivers, cable television receivers, satellite television receivers and/or other types of television receivers. A processor 322 is coupled to the interface 324 and processes the signals. In one aspect, the signals are digitized and encoded in a moving picture format such as MPEG. The MPEG signals can be stored in disk 328 or transmitted over Internet interface 326.

Subscribers 510a-510n typically communicate over the Internet with the ITV server to request delivery of television programs either in a real time or quasi real time basis, or stored and delivered on demand. The server typically streams the content to the subscribers in a compressed format, for example, MPEG. The subscribers will have a set top box or computer processor that can decode the content from the compressed format.

The ITV server manages the users, user interface and billing and payment. The subscribers typically subscribe to a particular type of access and the ITV server controls and grants the access. The ITV server also tracks the usage for payment of licensing fees to providers of content such as the television stations, cable stations (such as HBO and pay-per view, etc.), satellite stations, and other content providers (movie studios, etc.).

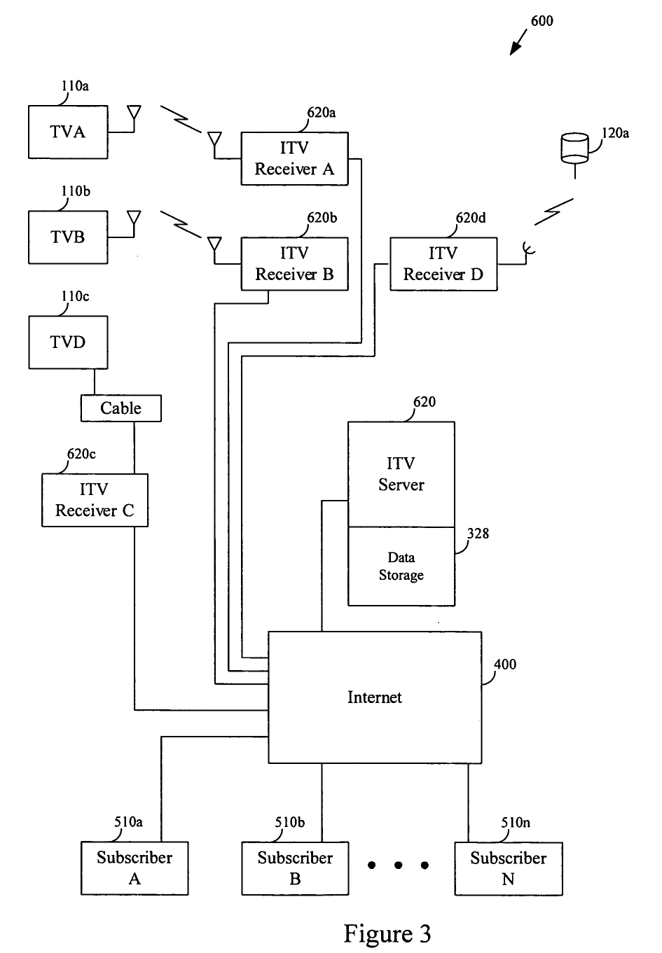

FIG. 3 depicts an architectural view of an Internet television broadcast system according to an embodiment of the invention. In this embodiment, a number of ITV receivers are located at geographically diverse locations and convert the television programming to a format that is sent over the Internet to the ITV server 620 for delivery to the subscribers.

In one embodiment, the data storage 328 includes paid content that subscribers can view on a paid basis, for example, movies, etc.

In other embodiments, an ITV server can be located at a subscriber residence for recording and/or download and storage of digital content. A recording of specific content or a time period can be specified in advance or programmed by a web interface over the Internet. Likewise, programming can also be accomplished over the television interface by a remote control or other suitable user device. The storage device can be programmed by a subscriber to record television programs by date and time or by title of the program.

In other embodiments, the storage device employs digital rights management to ensure the integrity of copyrighted content. This is particularly important when a content owner is concerned about maintaining the integrity of content and ensuring distribution only to subscribers who are entitled to access the content.

Advantages of the invention include the ability to view television programs over the Internet.

Having disclosed exemplary embodiments and the best mode, modifications and variations may be made to the disclosed embodiments while remaining within the subject and spirit of the invention as defined by the following claims.

1. An Internet television broadcast system comprising:
at least one television receiver for receiving a plurality of television signals;
a processor coupled to the television receivers and configured to selectively store television programs on a storage device and the selectively retrieve television programs from the storage device, and configured to selectively bypass the storage device;
an Internet interface coupled to the processor and configured to couple to the Internet; and
wherein the processor is configured to execute a program to selectively deliver requested television programs to subscribers over the Internet.

2. The Internet television broadcast system of claim 1, further comprising:
a plurality of television receivers for receiving signals from a plurality of television transmitters.

3. The Internet television broadcast system of claim 2, wherein:
at least one of the plurality of television receivers is positioned at a geographically distant location from the others.

4. The Internet television broadcast system of claim 1, wherein:
the storage device is configured to store television programs.

5. The Internet television broadcast system of claim 1, wherein:
the storage device can be programmed by a subscriber to record television programs.

6. The Internet television broadcast system of claim 1, wherein:
the storage device can be programmed by a subscriber to record television programs by date and time.

7. The Internet television broadcast system of claim 1, wherein:
the storage device can be programmed by a subscriber to record television programs by title.

8. The Internet television broadcast system of claim 1, wherein:
the storage device can be programmed over the Internet by a subscriber to record television programs.

9. The Internet television broadcast system of claim 1, wherein:
the storage device can be programmed locally by a subscriber to record television programs.

10. The Internet television broadcast system of claim 1, wherein:
the storage device employs digital rights management to ensure the integrity of copyrighted content.
